(19) United States
(12) Patent Application Publication
(10) Pub. No.: US 2006/0130776 A1
(43) Pub. Date: Jun. 22, 2006

(54) Domestic animal leading mechanism

(76) Inventor: Tzanis Fountoulakis, Dorentrup (DE)

Correspondence Address: LERNER GREENBERG STEMER LLP, P O BOX 2480, HOLLYWOOD, FL, 33022-2480, US

(21) Appl. No.: 11/292,476

(22) Filed: Dec. 2, 2005

(30) Foreign Application Priority Data
Dec. 3, 2004 (DE) 20 2004 018 817.1
Feb. 19, 2005 (DE) 20 2005 002 629.8

(51) Int. Cl. A01K 27/00

(52) U.S. Cl. 119/792

(57) ABSTRACT

A pet-leading device contains a collar, a flexible leash connected to the collar, and a wristband for attaching around a wrist of a person. The wristband functions as a winding core for the flexible leash, in which the flexible leash is wound up into a roll. In this manner, the leash is wound up in a convenient package and easily carried by the user.

The invention relates to a pet-leading device which is equipped with a collar and a flexible leash connected thereto.

It is generally known that many households keep one or more pets, in particular dogs or cats. These pets are included in the activities of the person, for example in leisure time when playing sport, when jogging, when cycling and the like. When people participate in such sporting activities, clothing is geared toward this activity, that is to say jackets and trousers are usually worn which are not intended for keeping relatively large articles in the pockets. The possibility of putting the dog leash away when not in use is therefore not open to the person in charge of the pet(s). On the other hand, it happens that the pet(s) must be put on the leash as it is not permitted everywhere to allow the pets to run free. Accordingly, it is realistic that the pet has to be put on and taken off the leash a number of times while walking.

The invention is based on the object of designing a pet-leading device of the kind described in greater detail in the introduction in such a way that the leash can when not in use be fixed to a body part in a convenient way by the person in charge of the pet. Moreover, it is possible to put the pet on the leash or take it off the leash in a very simple way and in a very short time.

The object set is achieved by the pet-leading device comprising a wristband, which can be attached around the wrist of a person, as a winding core for the leash which can be wound up into a roll.

It is then possible to wind the leash around the wristband when not in use, so that the coil consists of a number of plies according to the length of the leash. The wristband has to be designed in such a way that the individual plies remain unchanged even when the person moves. It can be assumed that the leash will not be lost even when the person participates in sporting activity and that moreover it will not be a hindrance. The wristband is worn constantly during the activity of a person.

The connection between the wristband and the leash can be designed in various ways. Provision is made for instance that this connection is designed as a separable or inseparable connection. In a preferred embodiment, provision is made that the end region of the leash assigned to the wristband is sewn together with the wristband. This embodiment affords the advantage that the two parts are interconnected unlosably and that the wristband is used instead of a loop.

If the connection between the leash and the wristband is to be separable, provision is made in a preferred embodiment that the connection between the wristband and the leash is effected by means of separably interconnected touch and close bands, one touch and close band being connected firmly on the outside of the wristband and a further touch and close band being connected firmly to the associated end region of the flexible leash. The advantage of such an embodiment is that the connection between the wristband and the leash is released automatically when a given tensile force is exceeded. This is the case, for example, if the pet to be led exerts an above-average force. It is consequently possible to prevent the person leading the pet from falling. A further advantage is also that the leash is exchangeable, in order to exchange a leash for another leash of different length for example. Instead of the touch and close bands, however, it is also possible for the connection between the wristband and the leash to be effected by means of press fasteners. These would also be released when a given tensile force was exceeded. In order that the touch and close bands or the press fasteners are always subjected to only shear forces, provision is made that an opening for the leash to be guided through is present in the end region of the wristband. This prevents the tensile forces acting on the leash acting on it at an angle or transversely to the touch and close bands or the press fasteners.

In order that the wristband can be placed and closed around the arm in a very simple way, provision is made that a touch and close element is fixed on the inside in one end region of the wristband and a further touch and close element is fixed on the outside in the opposite end region, so that the two touch and close elements form a touch and close fastener. However, press fasteners could also be used again instead of the touch and close elements. In order that a sufficiently large connection area is provided between the touch and close elements, provision is made that each touch and close element extends over the entire or approximately over the entire width of the wristband. As is explained below, the width of the wristband is appreciably larger than that of the leash. As the leash is guided through the opening, only those parts of the touch and close elements lying on the two sides of the leash are interconnected. It would accordingly also be possible for two bands to be arranged in each case in the end regions, the region for the leash then being free.

To further secure the plies of the coil, provision is made that the width of the wristband is larger than the width of the leash and that the lateral edges of the wristband project at the outside in relation to the central region. These raised edge regions should be designed in such a way that they lie approximately flush with the outer ply of the coil, so that the plies are effectively prevented from sliding off the wristband even when the body part is moved intensively.

In a preferred embodiment, provision is made that two securing elements corresponding to one another are fixed at a distance from one another in the region of the free end of the leash lying facing the wristband. This distance is selected in such a way that on the one hand the two securing elements interact in such a way that the coil formed from a number of plies is secured against unwinding and that on the other hand a loop can be formed from the free end region of the leash in order that the leash can be held securely when leading the pet.

In a preferred embodiment, provision is made that the securing elements are designed as plug-type connectors which can be brought into engagement with one another, one part being a firm molded part and the other part comprising two resilient catch tongues which engage behind webs in the fitted-together state. To release the connection, the resilient tongues are then moved toward one another. It is also possible, however, that the free end region is provided with a number of holes lying at a distance from one another which can alternatively be introduced into a buckle. It is furthermore possible that the securing element at the end can be operationally connected to a further securing element which is fixed in that region of the leash adjacent to the collar or on the collar itself. This affords the possibility of tying the pet to be led up to an object or to a tree, a post or the like. Although this is also possible in many cases with the loop at the end, this embodiment affords the advantage that the length of the leash is approximately halved and, although this results in the freedom of movement of the pet being limited, the force transmitted from the collar to the neck of the pet is nevertheless correspondingly reduced appreciably when the leash is pulled taut by a movement of the pet. When the pet is tied to an object, it must be assumed that the possible travel of the pet is twice the length of the leash. Correspondingly, the pet is tied up short by virtue of the additional securing element.

Provision is also made in a further development that the end regions of the wristband can be interconnected by the plug-type connectors already mentioned. The wristband can thus be placed around the wrist and also removed again in a very convenient way. In order that the size of the closed wristband can be varied, provision is made that at least one plug-type connector is fixed positionally adjustably on the wristband for changing the distance in relation to the associated plug-type connector. This is advantageously effected by means of a touch and close band which can be formed into a loop. Moreover, a predetermined break location is also correspondingly achieved in this way, so that the loop opens and the pet is freed when a given force is exceeded. Such cases could arise in particular when the pet is tied up to a fixed object by means of the pet-leading device. Apart from adaptation to the size of the wrist, changing the distance between the two plug-type connectors also has the advantage that the size of the wristband can also be adapted to the body part of a person.

The leash consists of either a non-extensible or an elastic strap. The elasticity has the advantage that, when a force is applied to the leash by the pet, the jolt occurring is correspondingly reduced.

Provision is also made in a further development that the wristband comprises a multi-layer strip and that at least the inner layer is made from a flexible material and the outer layer is made from a textile material, a braided material or the like. The flexible material could also be seen as padding, so that it is pleasant to wear the wristband, in particular when the leash is fixed on the wristband. The textile outer layer or the braided material affords the requisite loadability. In a preferred embodiment, provision is also made that the wristband consists of three layers and that a reinforcing layer is arranged between the outer layer and the inner layer. Moreover, the flexible inner layer provides what is known as a sweatband for the person wearing the wristband. Furthermore, the outer layer can be designed in such a way that it has a decorative effect.

Provision is also made in a further development that one plug-type connector is designed as a plug-type safety connector which opens at given loading, so that the leashed pet can then move around freely. This could happen, for example, when the pet experiences a panic situation and runs into the street and would pull the person leading the pet along with it. This plug-type safety connector could constitute the connection between the leash and the collar but could also be the connector which forms the loop. It is furthermore possible that the leash consists of two leash portions which can be connected by means of a plug-type safety connector. To form a loop by means of the end lying facing away from the collar, provision is also made that the end region is provided with a slit through which the leash is pulled. In this embodiment, the loop is tightened around the wrist in case of need but this affords the advantage that the loop cannot slide away over the hand.

During sporting activity, it is difficult to carry necessary articles and money along because of the sports clothing worn. In order to make it possible to carry keys, money etc. for example, provision is made that a pocket is fixed on one side of the wristband. This pocket is likewise made from a flexible material and should be of such a size that keys for doors and motor vehicles and money in the form of coins or notes can be put into it. In the most simple embodiment, provision is made that the pocket is designed as a flat pocket, that is two layers are interconnected in the edge regions, and the connection can also be a fold line. In order that this pocket is always fixed, provision is made that it can be placed over the outer surface of the wristband. Related to this use position of the pocket, provision is made that it has a closable opening on the side facing away from the wristband and that a touch and close strip, which can be operationally connected to a touch and close strip fixed on the wristband, is fixed on the other pocket side. In this way, the pocket is also fixed to the wristband in a very simple way. The opening is expediently closable. This can be effected by means of at least one two-part press fastener or by means of a zip fastener, for example.

If the leash is connected to the wristband by touch and close bands, this connection is released when a tensile force exerted by the pet is exceeded. If the connection between the leash and the wristband is fixed, however, the possibility should exist that the pet can move around freely when this tensile force is exceeded. Provision is therefore made in particular in these embodiments that a weakening line is provided for forming a predetermined tear location in the leash. This weakening line could be brought about by a reduction of the cross section of the leash, for example, or by introducing holes or slits.

The invention is explained in greater detail with reference to the accompanying drawings, in which:

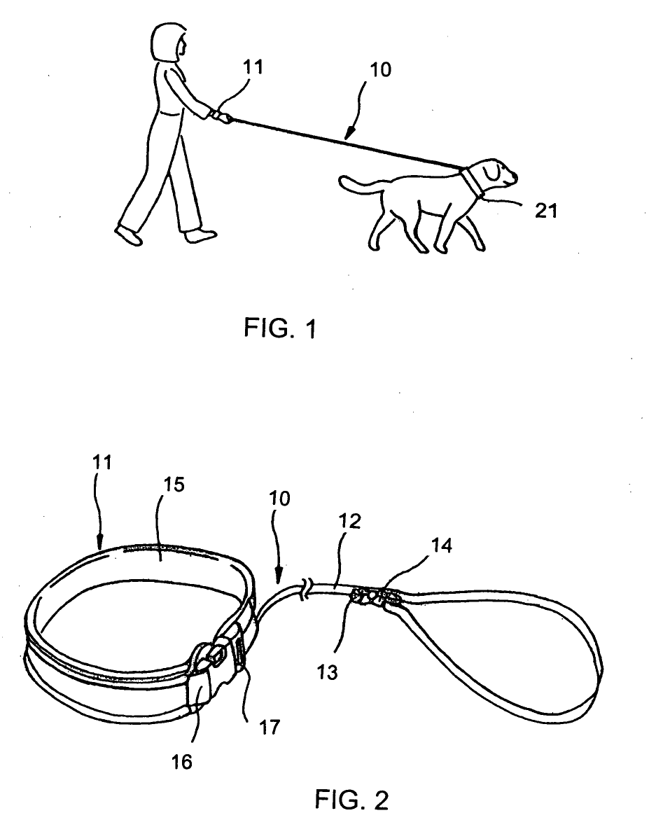

FIG. 1 shows a person leading a dog by means of the pet-leading device according to the invention;

FIG. 2 shows a perspective illustration of a preferred embodiment of the pet-leading device;

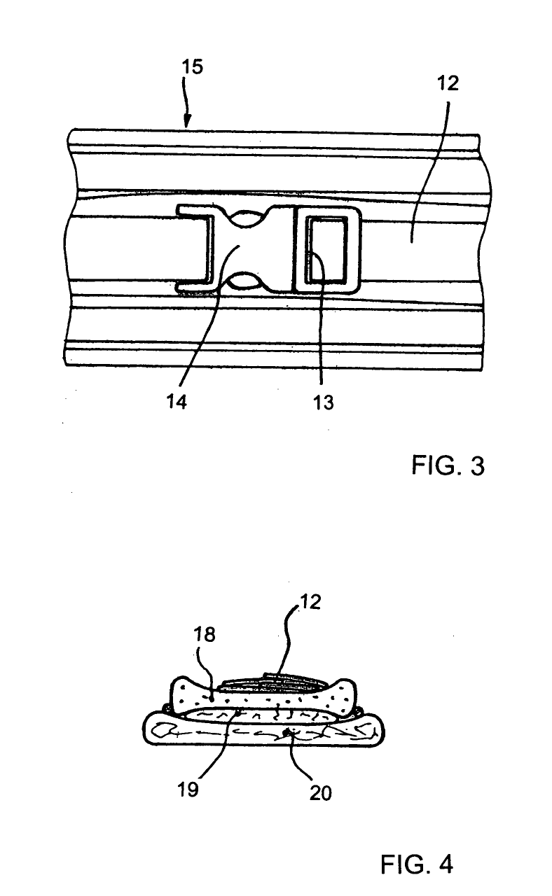

FIG. 3 shows a partial top view of the wristband in extended position;

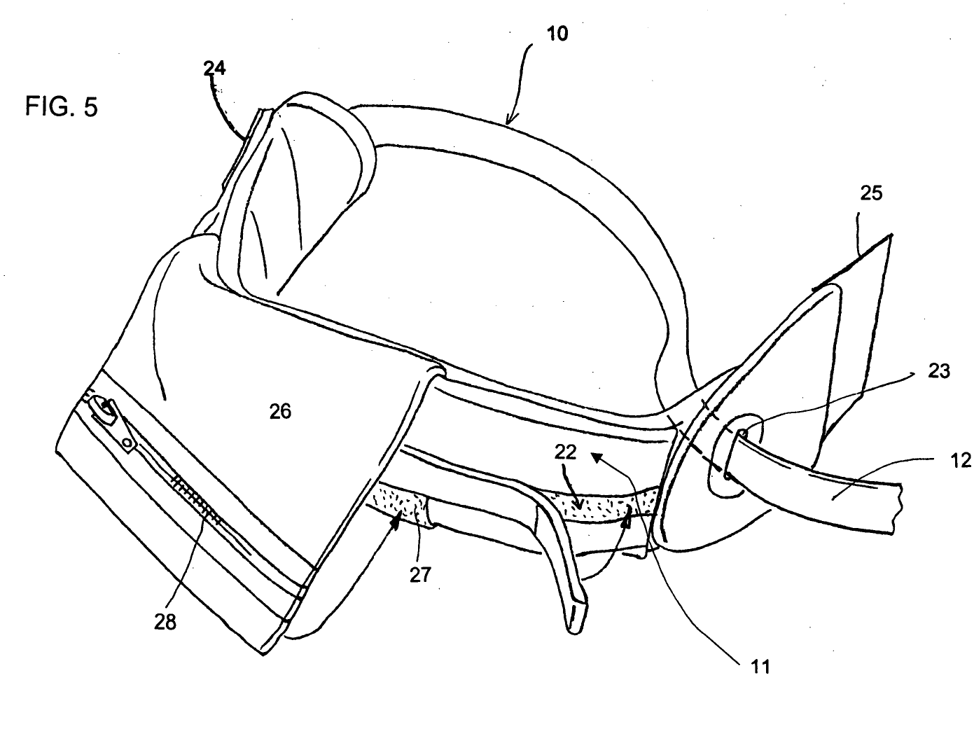

FIG. 4 shows a sectional illustration of the strips of the wristband, and

FIG. 5 shows a further embodiment of the pet-leading device.

FIG. 1 is intended to illustrate a person walking a dog by means of the pet-leading device 10 according to the invention. This pet-leading device 10 is illustrated in detail in a preferred embodiment in FIGS. 2 to 4. Accordingly, the pet-leading device 10 consists of a wristband 11 and a leash 12 connected firmly or separably thereto and a collar 21. In the free end region, that is the region facing the wristband 11, the leash 12 is provided with two plug-type connectors 13, 14 located at a distance from one another, which are positively interconnected in the fitted-together position illustrated in FIG. 2. For this, one plug-type connector 13 or 14 is provided with two resilient tongues which engage behind webs of the other plug-type connector 13 or 14 in the fitted-together state. The distance between the plug-type connectors 13, 14 is selected in such a way that the end region can be formed into a loop. The person leading the pet can thus hold the leash 12 securely, and the pet can also be tied up to a fixed object by means of the pet-leading device 10 if necessary.

In the illustrative embodiment shown, the leash 12 is sewn on with the end facing the wristband 11. In contrast to the illustration, the wristband 11 could be equipped with a ring and the end of the leash 12 could bear a snap hook. For opening and closing the wristband 11, the end regions of a strip 15 are likewise provided with plug-type connectors 16, 17, one plug-type connector 16 or 17 again being provided with two resilient catch tongues. It is also possible, however, for the connection to be brought about by a row of holes and a buckle.

In a way which is not illustrated, a further plug-type connector which forms a counterpart to the plug-type connector 14 arranged on the free end of the leash 12 could be fixed on the outside of the wristband 11, so that the latter plug-type connector can also be inserted into the former, by virtue of which the leash 12 can be shortened.

When the pet can move around freely, the leash 12 is taken off. After the loop at the end has been undone, the leash 12 is wound around the wristband 11 in a number of plies. The distance between the plug-type connector 13 and the plug-type connector 14 is selected in such a way that they can be fitted together again after the coil has been formed, so that a fixing element which secures the coil is brought about. In a way which is not illustrated further, at least one plug-type connector 16 or 17 is attached positionally adjustably to the strip 15, so that the size of the wristband 11 can be changed. For this, the plug-type connector 16, 17 to be adjusted is in a preferred embodiment fixed on the strip 15, which is formed by a touch and close strip for example, by means of a loop.

As FIGS. 2 and 3 show, the width of the leash 12 is appreciably smaller than that of the strip 15 of the wristband 11. FIG. 4 shows that the strip 15 of the wristband 11 consists of three layers 18, 19, 20. The lateral edges of the outer layer 18 are raised in such a way that the plies of the coil formed by the leash 12 are secured against lateral slipping. The central layer 19 could be a reinforcing layer made from a suitable textile material, a braided material, a woven material or the like, while the inner layer 20 facing the coat of the pet forms a padding. The pet-leading device 10 can thus also be worn comfortably by a person.

All suitable known connecting elements could be used instead of plug-type connectors 13, 14, 16, 17, an alternative possibility preferably being touch and close fasteners.

In the embodiment according to FIG. 5, the leash 12 is connected separably to the wristband 11. For this, the end region of that end of the leash 12 remote from the collar is provided on one side with a touch and close band which can be connected to a touch and close band 22 which is fixed on the outside of the wristband 11. It is thus possible to connect the leash 12 to the wristband 11 and to separate them in a very simple way. The advantage is furthermore afforded that the connection is released when a given tensile force exerted by the pet is exceeded, so that there is no risk of a fall or the like for the person leading the pet. Instead of the two touch and close bands, however, the connection could also be formed by a two-part press fastener or by a number of two-part press fasteners. In order that the connection formed by the touch and close bands 22 is subjected exclusively to shearing, an opening 23 through which the leash 12 is passed is provided in the wristband 11. The leash is correspondingly guided accurately in the region of the wristband.

For closing the wristband 11, a further touch and close element 24 is fixed on the outside on one end region. A further touch and close element 25 located on the inside is arranged on the opposite end region, so that the two touch and close elements 24, 25 can be operationally connected. This arrangement also makes it possible for the wristband 11 to be placed around the wrist in a very simple way. As FIG. 5 shows, the widths of the two touch and close elements 24, 25 correspond to the width of the wristband. This creates a connection area which is as large as possible. In contrast to the embodiment illustrated, it is also possible for two touch and close elements to be arranged at the side of the leash 12 in each end region as no interconnection of the touch and close elements 24, 25 takes place in the region of the leash 12 in the illustrative embodiment shown. Press fasteners could also be used for closing the wristband 11 instead of the touch and close elements 24, 25.

In the illustrative embodiment according to FIG. 5, a pocket 26 designed as a flat pocket is fastened to one edge of the wristband 11. This pocket 26 is designed in such a way that it can be placed over the wristband 11. For fixing, a further touch and close band 27 is fixed on the wristband 11, which is operationally connected to a touch and close band (not drawn) fixed on the pocket 26 when the pocket 26 is placed over the wristband 11. On the outside, the pocket 26 is provided with an opening which can according to the illustration be closed and opened by a zip fastener 28. If the pocket 26 is provided with an appropriately designed closure flap, press fasteners could also be used instead of the zip fastener 28. The pocket 26 is designed in such a way that it is movable in relation to the wristband.

It should also be mentioned that a pocket 26 can also be fixed on the wristband 11 in the embodiments according to FIGS. 1-4.

The invention is not limited to the illustrative embodiment shown. What is essential is that the leash 12 can be wound around the wristband 11 in the form of a multi-ply coil when the pet-leading device 10 is not in use and that the leash 12 is prevented from unwinding by at least one fixing element.

### Reference Numbers

10 pet-leading device
11 wristband
12 leash
13, 14 plug-type connector
15 strip
16, 17 plug-type connector
18, 19, 20 layers
21 collar
22 touch and close band
23 opening
24 touch and close element
25 touch and close element
26 pocket
27 touch and close band
28 zip fastener

1-26. (canceled)

27. A pet-leading device, comprising:
a collar;
a flexible leash connected to said collar; and
a wristband for attaching around a wrist of a person, said wristband functioning as a winding core for said flexible leash being wound up into a roll.

28. The pet-leading device according to claim 27, further comprising a connection between said wristband and said flexible leash, said connection selected from the group consisting of a separable connection and an inseparable connection.

29. The pet-leading device according to 28, wherein said connection between said wristband and said flexible leash includes separably interconnectable touch and close bands including a first touch and close band connected firmly on an outside of said wristband and a second touch and close band connected firmly to an end region of said flexible leash.

30. The pet-leading device according to claim 29, wherein said wristband has a further end region with an opening formed therein for receiving and guiding said flexible leash therethrough.

31. The pet-leading device according to claim 27, further comprising:
a first touch and close element fixed on an inside in a first end region of said wristband; and
a second touch and close element fixed on an outside in a second end region of said wristband, being opposite said first end region, said first and second touch and close elements forming a closure.

32. The pet-leading device according to claim 31, wherein said first and second touch and close elements each extends over an entire or approximately over an entire width of said wristband.

33. The pet-leading device according to claim 28, wherein said connection includes an at least one two-part press fastener.

34. The pet-leading device according to claim 28, wherein said flexible leash has an end region sewn onto said wristband.

35. The pet-leading device according to claim 27, wherein said wristband has a width being larger than a width of said flexible leash, and said wristband has a central region and lateral edges projecting at an outside in relation to said central region.

36. The pet-leading device according to claim 27, further comprising two securing elements corresponding to one another and fixed at a distance from one another in a region of a free end region of said flexible leash lying facing said wristband.

37. The pet-leading device according to claim 36, wherein said securing elements are plug-type connectors which can be brought into engagement with one another.

38. The pet-leading device according to claim 36, wherein said securing elements include a first element and a second element, said first element disposed at said free end and can be operationally connected to said second securing element fixed in that region of said flexible leash adjacent to said collar or on said collar itself.

39. The pet-leading device according to claim 36, wherein said wristband has end regions with plug-type connectors that can be interconnected to each other.

40. The pet-leading device according to claim 39, wherein at least one of said plug-type connectors is fixed positionally adjustably on said wristband for changing a distance in relation to another associated one of said plug-type connector.

41. The pet-leading device according to claim 40, further comprising a touch and closed band which can be formed into a loop for fixing said at least one plug-type connector.

42. The pet-leading device according to claim 27, wherein said flexible leash contains a non-extensible or an elastic strap.

43. The pet-leading device according to claim 27, wherein said wristband is formed as a multi-layer strip having at least an inner layer made from a flexible material and an outer layer made from a material selected from the group consisting of textile materials and braided materials.

44. The pet-leading device according to claim 43, wherein said multi-layer strip contains three layers including a reinforcing layer disposed between said outer layer and said inner layer.

45. The pet-leading device according to claim 39, wherein at least one of said plug-type connectors is plug-type safety connector which can be released automatically depending on loading.

46. The pet-leading device according to claim 27, wherein said flexible leash has an end region with a longitudinal slit formed therein, said end region facing said wristband for forming a loop.

47. The pet-leading device according to claim 27, further comprising a pocket fixed on one side of said wristband.

48. The pet-leading device according to claim 46, wherein said pocket is a flat pocket and can be placed over an outer surface of said wristband.

49. The pet-leading device according to claim 47, wherein:
said wristband has a first touch and close strip; and
said pocket has a closable opening on a first pocket side facing away from said wristband, and a second touch and close strip fixed on a second pocket side disposed opposite said first pocket side, said second touch and close strip can be operationally connected to said first touch and close strip fixed on said wristband.

50. The pet-leading device according to claim 47, further comprising at least one two-part press fastener fixing said pocket on wristband.

51. The pet-leading device according to claim 27, wherein said flexible leash has a weakening line for forming a predetermined tear location.

52. The pet-leading device according to claim 51, wherein said predetermined tear location is formed by a reduction of a cross section of said flexible leash, by openings or by slits formed in said flexible leash.
